(19) United States
(12) Patent Application Publication
(10) Pub. No.: US 2008/0219636 A1
(43) Pub. Date: Sep. 11, 2008

(54) Authoring Audiovisual Content

(75) Inventor: Stuart Green, Sheffield (GB)

Correspondence Address: BAINWOOD HUANG & ASSOCIATES LLC, 2 CONNECTOR ROAD, WESTBOROUGH, MA, 01581, US

(73) Assignee: ZOOTECH LIMITED, Sheffield (GB)

(21) Appl. No.: 11/909,316

(22) PCT Filed: Mar. 3, 2006
(86) PCT No.: PCT/EP06/61022

§ 371 Date: Mar. 19, 2008

(30) Foreign Application Priority Data
Mar. 24, 2005 (GB) 0506037.1

(51) Int. Cl. H04N 5/93

(52) U.S. Cl. 386/52

(57) ABSTRACT

Aspects and embodiments of the present invention relate to an authoring system for authoring an audiovisual production, for example for storage on a DVD-Video disc. The audiovisual production typically comprises audiovisual context and accompanying captions and the authoring system typically comprises: a first data store for storing audiovisual assets; a second data store for storing raw caption data; means for generating caption assets, using the raw caption data, and storing the caption assets in a third data store; and, means for generating the audiovisual production, using at least the audiovisual assets and the caption assets, and storing the audiovisual production in a fourth data store. Certain embodiments of the present invention find particular application in the field of DVD authoring including subtitle authoring and subtitle localisation.

The present invention relates to authoring audiovisual content and particularly, but not exclusively, to authoring audiovisual content including textual content for accompanying playback of the audiovisual content.

It is known to augment or enhance an audiovisual production, for example a television programme or a movie, with textual content. Examples of textual content include subtitles, NTSC Closed Captions, PAL Teletext and the like. Subtitles, for example, can be used to provide a text-based translation of spoken content, for viewers who are not fluent in the spoken language. Subtitles typically appear at the bottom of the viewable area of display equipment, for example a television screen, and generally correspond to the speech of on-screen characters. Closed Captions and Teletext, on the other hand, are mainly aimed at hearing-impaired viewers and include spoken words as well as indicia of other kinds of sounds, such as music, animal sounds, thunder and the like. Closed Captions and Teletext can appear at the bottom of a television screen or near to, for example below, a person or object from where a sound emanates.

Another kind of textual content, which can be displayed to augment or enhance an audiovisual production, is background information. For example, the background information might include facts, trivia, statistics, web site links or other information, which is relevant to, but not an inextricable part of, the main subject matter of the audiovisual production. In this context, background information can also include on-screen options, or the like, which may be selected by a user in order to access more detailed information.

Another kind of textual content is commercial information, for example, an advertisement, or seller information, relating to a product, clothing or a gadget, which is displayed or portrayed in an audiovisual production.

In principle textual content may also include other information, which may not relate directly or even indirectly to the audiovisual content being replayed.

In any of the foregoing examples, the textual content may appear as one or more static images, which are displayed in a region (or regions) of a display screen during the playback of an audiovisual production. The image(s) may appear to overlay visual content or reside in a different region of the screen. The image(s), in general, may change when a speaker, scene, subject or viewing angle of the audiovisual content changes. Alternatively, the textual content may comprise a dynamic image, for example text that scrolls within a region of the screen, or an animated text-based image.

In practice, subtitles, Closed Captions and Teletext are provided for display in slightly different ways. With respect to an audiovisual production that is broadcast, for example, subtitles generally form a composite part of the visual content; and a viewer cannot, typically, selectively switch subtitles on or off. In contrast, Closed Caption and Teletext content can be decoded independently of other audiovisual content in a transmission. For example, in the United States, all television sets having a screen size larger than 13 inches have by law since 1993 required a Closed Caption decoder. Teletext, on the other hand, is predominantly European and is not mandatory. Not all programmes in Europe include a Teletext data stream and not all European televisions include a Teletext decoder. In either the case of Closed Captions or Teletext (if available), the display of the respective textual content can be switched on of off, depending on viewer choice, by controlling the display equipment that contains an appropriate decoder.

Textual content can also be provided with a pre-recorded audiovisual production, which is typically stored on a storage medium, such as a VHS-Video cassette, a DVD-Video disc or the like. Closed Captions that are provided on VHS or DVD media form part of an MPEG-2 data stream, and can be selectively switched on or off via the usual television control. On VHS media, like the broadcast equivalent, subtitles are typically included as a composite part of the visual content and cannot be turned on or off. On DVD media, however, subtitles are typically provided in one or more subpicture streams, which are independent of the main audiovisual content data stream. Accordingly, in contrast with broadcast and VHS-based subtitles, DVD-based subtitles can be switched on and off using standard DVD playback equipment or software.

The advent of DVD technology and, in particular, the DVD-Video format, has greatly increased the playback options that are available to an author and a viewer, respectively, during audiovisual production authoring and playback. For example, DVD-Video, which will be referred to hereinafter simply as “DVD”, provides plural interleaved data streams, which can be used for recording and playing back different kinds of content. In particular, there is provision for up to: nine camera angle streams, which can be used, as their name suggests, for presenting different camera angles of the same event; eight audio streams, which may be used, for example, to present the same dialog in different languages; and thirty-two graphic overlay data streams, called subpicture streams, which can be used for subtitles, captions, menus or simple animations.

The provision of plural subpicture streams, which can be user-selected for display during audiovisual production playback, facilitates the option for a DVD author to provide subtitles in plural different languages. Indeed, many DVD titles published nowadays include at least one, and typically several, sets of subtitles in different languages. Typically, a user can select, via an on-screen menu, one of the subtitle language streams for display. In principle, the textual content normally provided by Closed Captions can instead, or in addition, be provided using subpicture streams rather than a dedicated Closed Caption data stream.

An ongoing challenge for any DVD author (which may be a person, people or a company) is the efficient and cost-effective generation and production of a DVD product. In particular, providing subtitles in multiple languages is a significant overhead in DVD production. A subtitle authoring process typically comprises at least the following four main steps.

Step a) A human subtitling operator, who is fluent in a target language, watches a reference copy of an audiovisual production and generates, for each section of speech, subtitle text and corresponding time codes, which identify start and end times for the respective subtitle text. Additional information can be furnished at this time: for example choice of text font, size, colour and placement.

Step b) The subtitle text file is transferred to a subtitle author, who typically uses subtitle-authoring software to generate a graphical image of each section of subtitle text. Each section of speech is typically converted into a separate image file, for example a TIFF or Targa formatted file. These image files are eventually included in DVD subpicture streams. In addition, the subtitle author typically generates a script file, which is used by respective DVD authoring software (in step d hereinafter)) to ensure correct physical and temporal placement of the subtitle image file in its respective subpicture stream. A script file typically contains at least a list of the image files and their intended start and end times. The script file is typically arranged in a known way according to which authoring software package is to be used.

In some scenarios, steps a) and b) may be carried out by the same person.

Step c) A DVD author imports into a DVD authoring system all of the generated image files and respective script files, which together are commonly referred to as audiovisual assets.

Step d) The DVD author creates a DVD image using the pre-prepared audiovisual assets, as well as other associated audiovisual assets, including, for example, the main video and audio assets, interactive menu images and the like.

During a typical authoring process, an author creates a DVD project by gathering together or importing all the necessary audiovisual assets and creating a data structure, which includes a reference to each asset and respective start and end times. The data structure also includes navigation information, which defines how a user can interact with and replay the content that is on a resulting DVD. The navigation information is typically stored in IFO files on a DVD, whereas the audiovisual content is stored in VOB files. The authoring system uses the data structure to build or generate the DVD image in a known way.

Basically, a DVD image comprises a hierarchical data structure comprising data files that are arranged substantially in an order in which they would appear on a DVD-Video disc. The files contain packetised and multiplexed data that represent the navigation and presentation information of a DVD-Video production. A DVD image is typically generated using an authoring system, stored on a hard disc, and then (directly or indirectly) written to a DVD at a later time.

In a commercial scale DVD production process, once created, the DVD image is stored onto a high capacity storage medium, for example a Digital Linear Tape (DLT) medium, which is used to generate a DVD master disc, which, in turn, is used for pressing production DVD.

The audiovisual assets that are imported into the authoring system are typically in a rendered format, which can be used directly for authoring. For example, audio assets may be in a PCM format, video assets may be in a MPEG-2 format, and menus and graphic overlays may be in a bitmap image format. Of course, the authoring system may include the capability to convert some assets between rendered formats. For example, it may be necessary to convert between PAL and NTSC, alter video aspect ratios or apply compression or noise reduction to rendered assets. Finally, in the process of authoring, the assets are ordered, packetised and arranged into respective data streams, which are multiplexed to form a DVD image.

A typical Closed Caption authoring process is similar to the foregoing subtitle authoring process. In Step b) of an equivalent Closed Caption authoring process, however, a caption author generates a caption file, which typically comprises a text file containing time codes, position codes and hexadecimal characters, which represent the required caption text. In all other respects the process is substantially the same.

Background information and commercial information for use in an audiovisual production can also be generated in a similar fashion.

For convenience, and unless otherwise indicated, the term “caption” (or, in the plural, “captions”) will be used hereinafter to encompass, without limitation, all of the aforementioned kinds of textual, or text-based, content including:—Closed Captions, Teletext, subtitles, background information and commercial information, which can be used to enhance or augment an audiovisual production. As indicated, captions, in this context, are typically generated independently of the main audiovisual content and are then combined with the main audiovisual content as part of a post-production process.

An aim of embodiments of the present invention is to provide an improved authoring system and method.

According to a first aspect, the present invention provides an authoring system for authoring an audiovisual production comprising audiovisual content and accompanying captions, the system comprising: a first data store for storing audiovisual assets; a second data store for storing raw caption data; means for generating caption assets, using the raw caption data, and storing the caption assets in a third data store; and, means for generating the audiovisual production, using at least the audiovisual assets and the caption assets, and storing the audiovisual production in a fourth data store.

A data store may be volatile, for example comprising random access memory (RAM), or non-volatile, for example comprising magnetic storage, such as a hard disk, optical storage, such as a CD, a DVD or the like, or electrically-(re)writable memory, such as Flash™ memory.

As will be seen herein, unlike in prior art apparatus and systems, which require caption assets to be rendered or generated and provided in advance, aspects and embodiments of the present invention use raw caption data and generate the caption assets, for example, as part of the overall audiovisual production building or compilation procedure. An advantage of embodiments of the present invention is that it is only necessary to transmit to an author a small text-based file or files, or a database, containing raw caption data, rather than a large number of, for example, rendered image files. Additionally, according to embodiments of the present invention, the potential for errors occurring, in the process of transferring large image files to an author, is removed or at least reduced. Furthermore, embodiments of the present invention enable an author to amend caption content, even after it has been imported into an authoring system. In a typical prior art authoring process, amendments to caption content require the author to revert to a subtitling operator, or subtitle author, in order to have amendments made. This typically requires the author to contact personnel in other companies or organisations, which can take considerable time and effort. Indeed, for example, if a change needs to be made to subtitles in plural different languages, then it is normally necessary to contact plural different personnel in different organisations in order to achieve an appropriate amendment.

The authoring system may comprise means for generating a data structure including references to stored audiovisual assets and stored raw caption data. Indeed, the system may comprise means for generating an expanded data structure including references to stored audiovisual assets and individual caption frames, which are identified in the stored raw caption data.

A data structure, or an expanded data structure, may comprise an array of data, which may be arranged as at least one information file, for example a text-based information file or script file. The data structure or expanded data structure may comprise plural information or script files. The data structure or expanded data structure may be held in volatile memory, for example RAM, or in non-volatile memory.

In some embodiments, at least some of the references include: caption text; timing information (for example, the timing information may relate to a start time, an end time, or both, of a caption in the audiovisual production); storage path or location information; caption-formatting information (for example, formatting information may relate to font style, font size, text colour, kerning, or any other kind of formatting information); or, a data stream identifier. In the case of a DVD product, for example, a stream identifier may comprise a subpicture stream number or reference.

In some embodiments, references may include some or all of the foregoing features.

The authoring system may comprise means for generating the audiovisual product with accompanying captions including by using a data structure or an expanded data structure.

The raw caption data may comprise plural text structures. For example, each text structure may comprise a word or words, sentences, phrases or the like. In addition, the structures may comprise character strings or text strings, comprising plain text or formatted text, or text that is represented or encoded in some other way. The structures may, for example, be stored in a data array, a text file, a spreadsheet, a database, or in another kind of suitable text repository.

The raw caption data may comprise timing data, which associates each text structure with a temporal point in the audiovisual product. The timing data may be absolute and comprise, for example, start and end times or a start time and a duration. Alternatively, the timing data may be relative to another time, or even to a physical point, in the audiovisual product. For example, the timing data may specify a temporal point in terms of a particular scene or chapter number of a respective audiovisual product.

The raw caption data may comprise formatting data, which describes a visual appearance associated with the text structures. Formatting data may include identifiers for font type, font size, font colour, character spacing, whether text is bold, italic or underlined, among many other possible attributes.

The raw caption data may comprise placement data, which specifies an on-screen physical placement associated with at least some of the text structures. For example, in the case of subtitles, the placement data may determine a text window size at the bottom of a display screen. In the case of Closed Captions, the placement data may comprise (x, y) co-ordinates for where text appears on a display screen.

In at least some embodiments, the plural text structures comprise sets of text structures. The sets of text structures may each comprise equivalent and alternative text. For example, one set may comprise explicit text, suitable only for adults, while another set may be modified for a younger audience.

Each set of text structures may comprise an individual data file. For example, the raw caption data may comprise plural individual data files. In any event, a data file may be a text-based file.

Each set of text files may comprise substantially equivalent text in a different language. As such, embodiments of the present invention find particular application for generating audiovisual products that incorporate subtitles in plural languages.

The caption assets may comprise rendered image files. For example, the image files may be bitmap, TIFF or Targa files. Alternatively, or in addition, the caption assets may comprise one or more formatted text files. Then, the or each formatted text file may contain character codes representing text to be displayed.

The or each formatted text file may contain at least one of timing information, formatting information and placement information, associated with each of the character codes. The formatted text file may, for example, be formatted according to a Closed Caption data format.

According to a second aspect, the present invention provides a method of authoring an audiovisual production comprising audiovisual content and accompanying captions, comprising the steps: providing audiovisual assets and raw caption data; generating a data structure including references to the audiovisual assets and raw caption data; generating caption assets, using the raw caption data; and generating the audiovisual product by using the data structure and at least the referenced audiovisual assets and caption assets.

The method may include the step of expanding the data structure by including references to stored audiovisual assets and individual caption frames, which are identified in the stored raw caption data.

The method may include the step of altering the raw caption data, in-situ, after it has been provided.

Other features, embodiments and aspects of the present invention will are described in the following description and claims.

Exemplary embodiments of the present invention will now be described with reference to the accompanying drawings, of which:

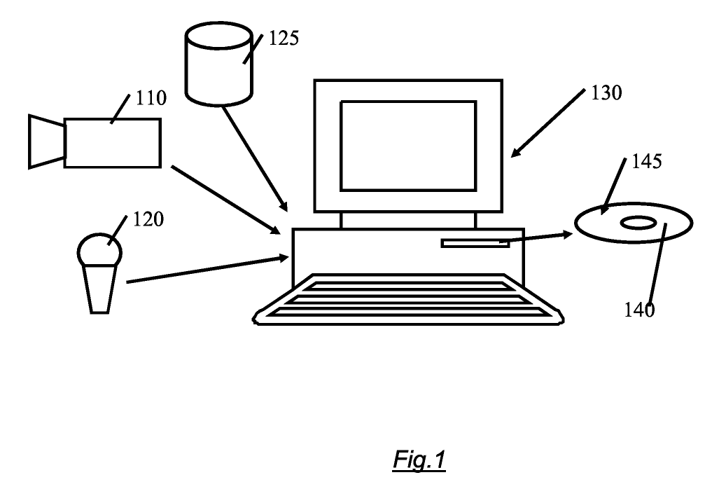

FIG. 1 is a diagram that illustrates a typical authoring system hardware arrangement;

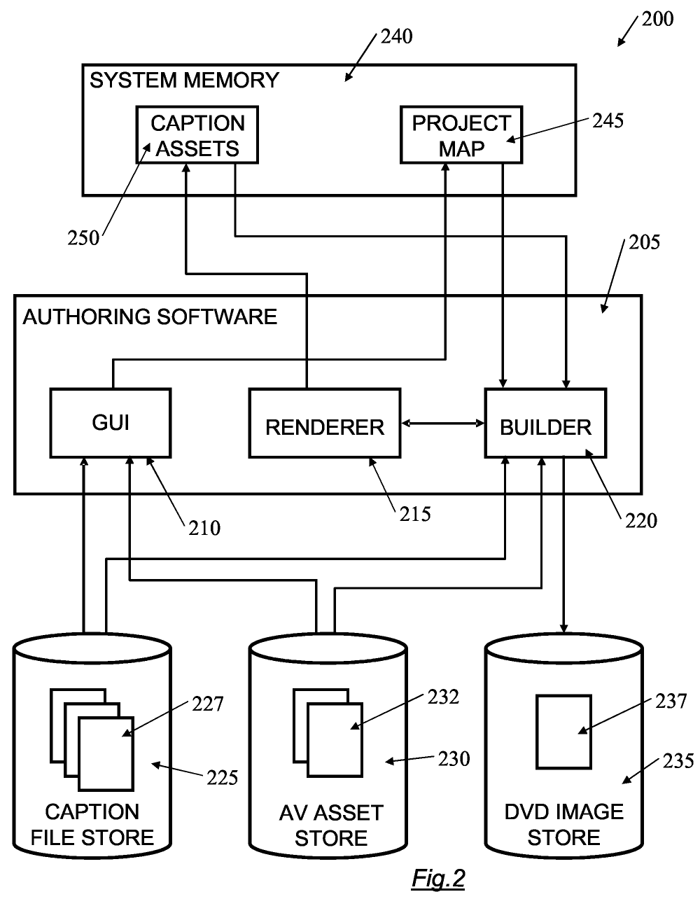

FIG. 2 is a functional block diagram of an authoring system arrangement according to embodiments of the present invention;

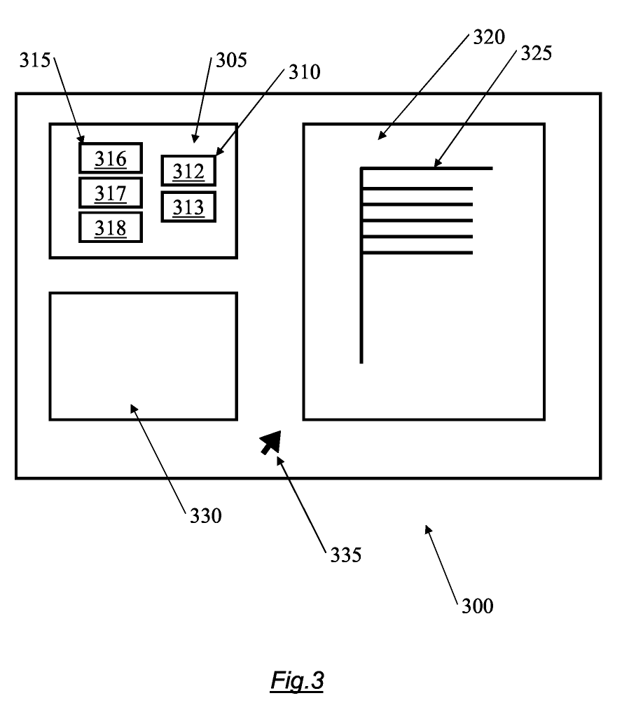

FIG. 3 is a diagrammatic representation of a GUI environment for use in embodiments of the present invention;

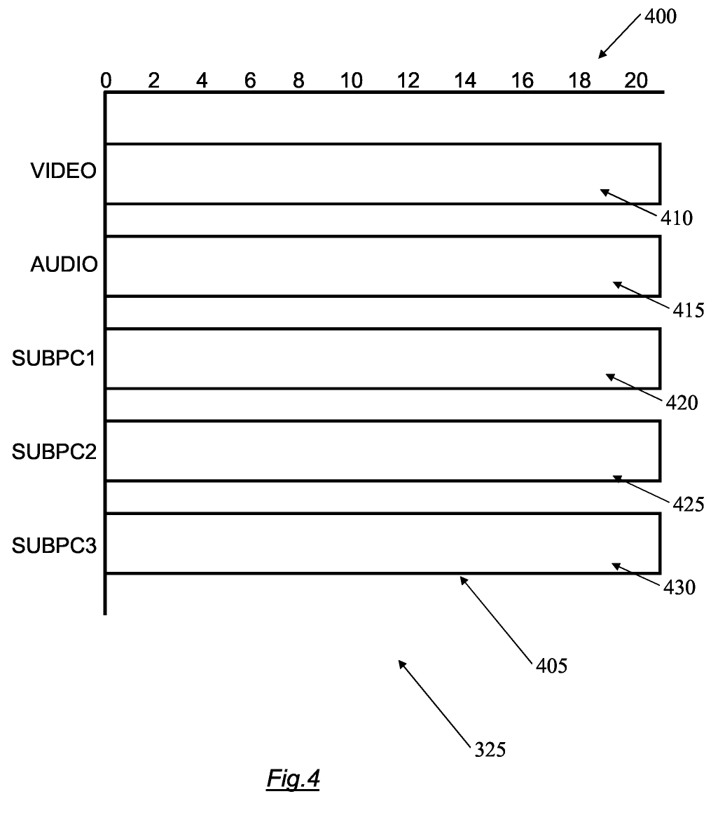

FIG. 4 is a graphic representation of a timeline process, which forms a part of a GUI for use in embodiments of the present invention;

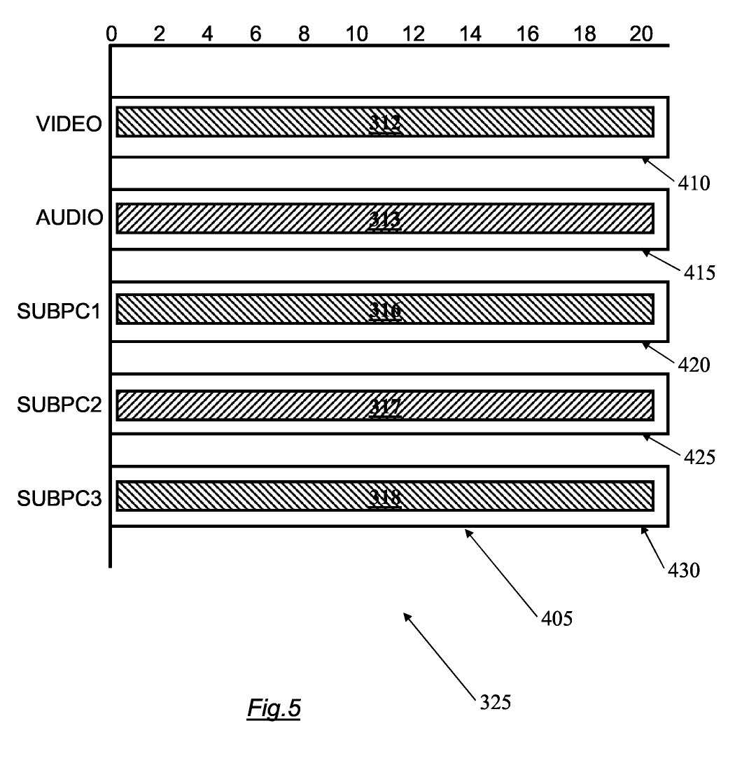

FIG. 5 is a graphic representation of the timeline process of FIG. 4 after audiovisual assets and caption data have been registered;

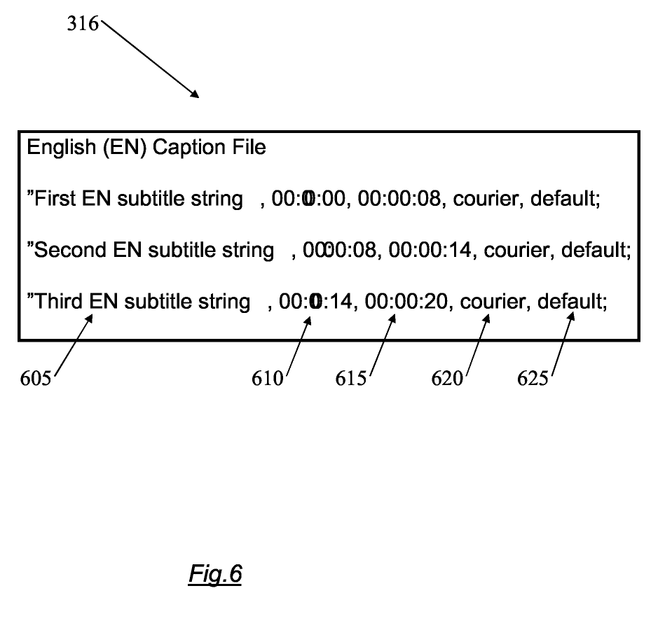

FIG. 6 is an exemplary text-based caption file;

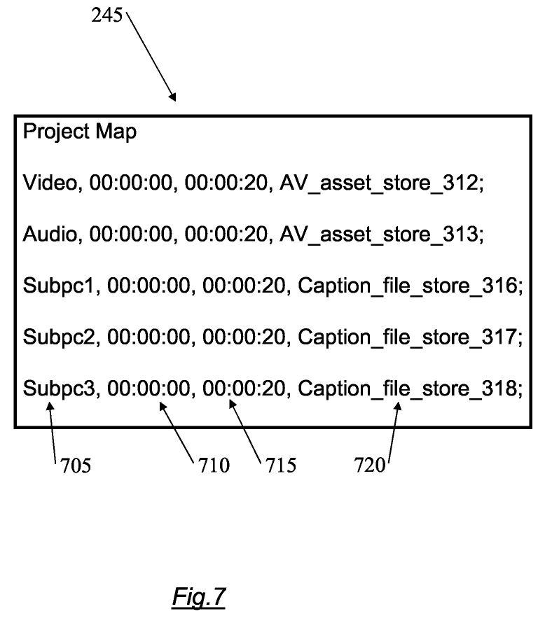

FIG. 7 is an exemplary text-based DVD project map;

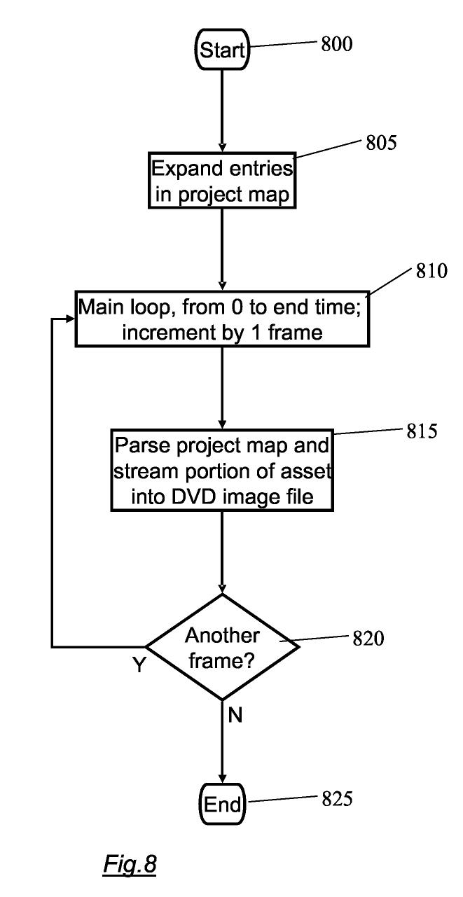

FIG. 8 is a flow diagram representing a process for generating an audiovisual product according to embodiments of the present invention;

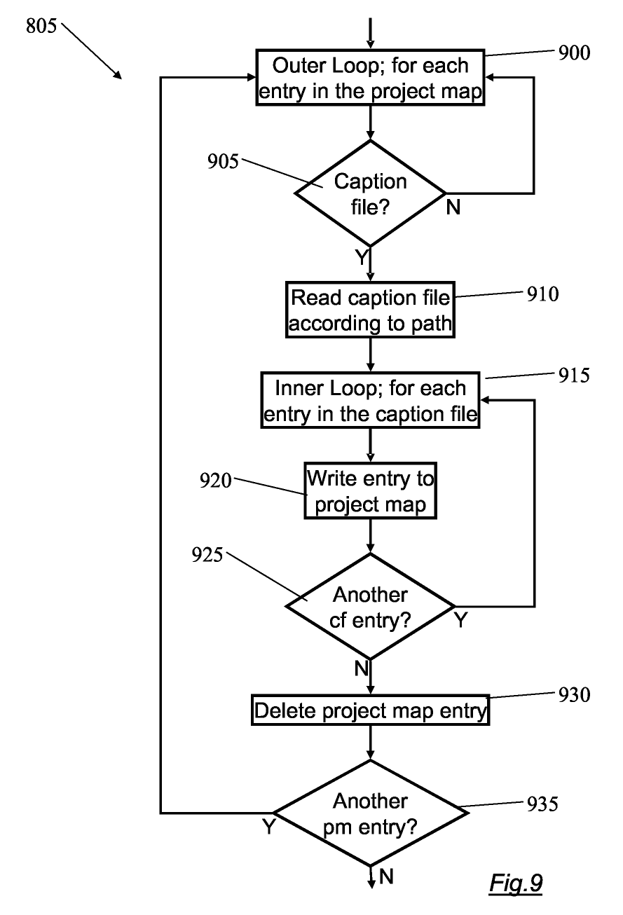

FIG. 9 is a flow diagram representing a process for expanding entries in a DVD project map to include individual references to caption frames;

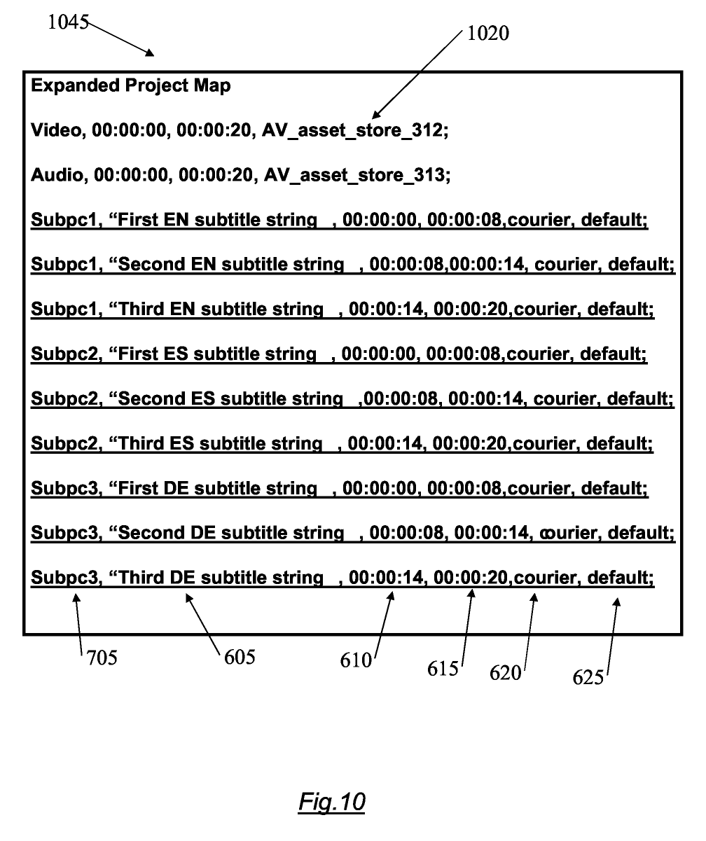

FIG. 10 is an exemplary text-based DVD project map, which has been expanded according to the process illustrated in the flow chart in FIG. 9; and

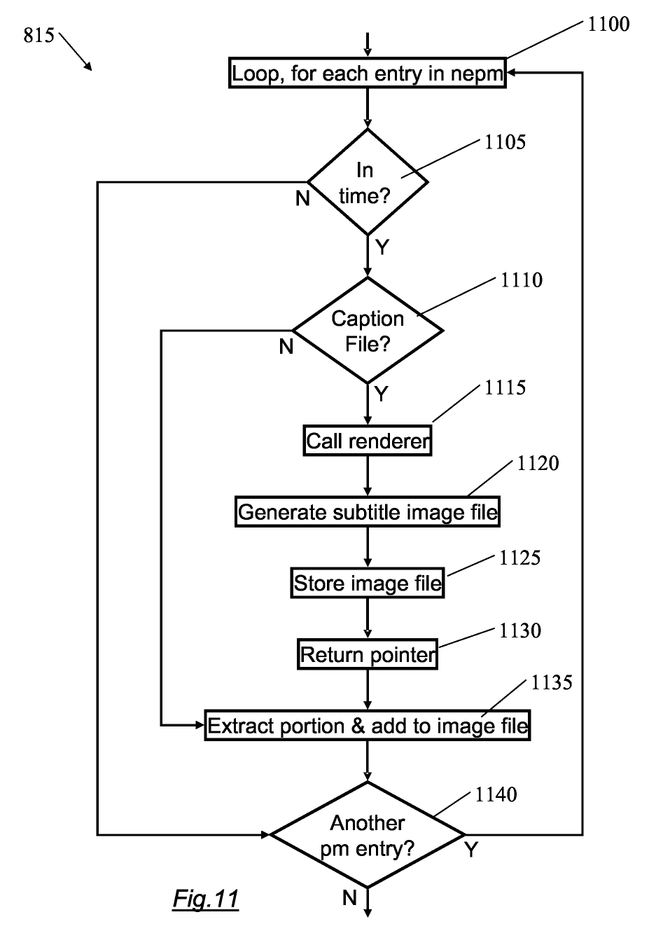

FIG. 11 is a flow diagram representing a process of building a DVD image in accord with embodiments of the present invention.

An embodiment of the present invention will now be described by way of example by considering an authoring procedure for a DVD-Video disc, although, of course, the underlying principles apply equally to authoring for other data carriers and data formats, for example—without limitation—Video-CD, Blu-Ray optical disc and HD-DVD optical disc. In particular, the principles associated with preparing caption assets can be applied very generally to producing an audiovisual product in any audiovisual format.

By way of background, a typical, exemplary, basic audiovisual authoring apparatus of a known kind is illustrated in the diagram in FIG. 1. The authoring apparatus includes an appropriately programmed computing platform, such as a client-server computer system, or a stand-alone personal computer, 130. Optionally, audio and video data are captured, such as through a camera 110 and a microphone 120, or are provided from other sources such as a local file storage device 125, or remote storage (not shown), or are created within the authoring apparatus, for example, using image and sound capture and creation software. The content data, which is stored as audiovisual assets, may include video clips, audio clips, still picture images, icons, button images and other visual content to be presented onscreen. The assets are suitably in the form of fully rendered MPEG, JPEG or bitmap encoded files, but may take any suitable format.

An authored audiovisual production can be a movie, a company presentation, or a quiz game, amongst many other possibilities. The computer 130 is arranged to create the desired audiovisual production 145 and write it onto a storage medium such as a hard disk drive 125 within the computer 130, an external storage device (not shown) or onto an optical disk product 140.

The process of authoring audiovisual products can be complex and difficult for the non-skilled author. However, the task may be greatly simplified by using one of the many software authoring systems that are commercially available, for example Scenarist™ (from Sonic Solutions™), DVD Studio Pro™ (from Apple), DVD EXTRA-STUDIO™ (from ZOOtech Limited), Pinnacle Studio or Encore™ (from Adobe™). An advantage of using one or more of these systems is that it is not necessary to understand in detail the DVD-Video format specification in order to produce a compliant audiovisual product, since each authoring system is able to assemble high-level design information and audiovisual assets, which are provided by an author, into format-compliant audiovisual content. In any event, for example, the person skilled in DVD authoring will clearly have a more detailed working knowledge of the DVD-Video format specification and should be able to generate an audiovisual production with or without using an authoring system; although, for sheer convenience and expedience, use of such a system would be preferable.

An authoring system according embodiments of the present invention uses authoring apparatus substantially of the kind illustrated in FIG. 1. However, an authoring system according to embodiments of the present invention is adapted to generate caption assets from raw caption data, as will be described hereinafter.

An exemplary authoring system will now be described for producing a DVD product, which includes subtitles.

The diagram in FIG. 2 is a functional block diagram representation of an authoring system 200 according to an embodiment of the present invention. As shown in FIG. 2, a computer 130 is programmed with authoring software 205.

As is well known, authoring software, for example Scenarist or DVD EXTRA-STUDIO, typically provides an author with a convenient GUI and many subsystems and options, which enable the author to generate audiovisual products in an efficient manner. A majority of these subsystems and options are well documented elsewhere and, therefore, need not be described herein in any significant detail.

As shown in FIG. 2, the present authoring system 200 is programmed with authoring software 205, which includes a graphical user interface (GUI) process 210, a renderer process 215 and a builder process 220. The system also includes: a caption file data store 225, for storing caption files 227; an audiovisual (AV) asset data store 230, for storing audiovisual assets 232; and a DVD image data store 235, for storing a completed DVD image 237. The data stores typically reside in hard disc storage 125, although some or all of the respective data may be temporarily stored and manipulated in a main system memory 240, for example, comprising RAM. In addition, a project map 245 and caption assets 250 are generated and stored in the main system memory 240. All of these components of the authoring system 200 will be described in more detail hereinafter.

The GUI, which is of a generally known kind, enables the author to design a DVD project and build a corresponding DVD image, using pre-prepared audiovisual assets 232 and the caption files 227. An exemplary GUI 300 is illustrated schematically in the diagram in FIG. 3. According to FIG. 3, the GUI 300 provides at least: a first area 305, containing graphical icons 310 representing each of the audiovisual assets 232 and graphical icons 315 representing each of the caption files 227 that are available for use in the DVD project; a second area 320, providing a graphical timeline 325 to represent the DVD project; and, a third area 330, providing a properties dialog box for a selected audiovisual asset on the timeline. As shown in the first area 305, there are two audiovisual assets 232: a 20 second video clip 312, which is in an appropriate movie format; and, a corresponding 20 second audio clip 313, in an appropriate audio format. According to the present embodiment, the first area 305 of the GUI in addition contains three icons 315 representing three caption files 227: for English 316, Spanish 317 and German 318 subtitles. The three caption files will be described in more detail hereinafter. The diagram in FIG. 3 also illustrates a pointer icon 335, the position on screen of which is controlled by an author, for example using a standard computer mouse device (not shown).

The graphical timeline 325 is illustrated in more detail in the diagram in FIG. 4.

As shown in FIG. 4, the timeline 325 extends from left to right, with the respective timing information 400 on an x-axis across the top of the timeline. In this example, the timings are shown in two-second intervals, from 0 to 20, but they may, if necessary, be represented in shorter intervals, for example down to granularity of the screen repetition, or frame, rate of a typical PAL or NTSC production. The granularity would be set using an appropriate GUI setting.

The timeline 325 represents DVD data streams as horizontal bars 405, for each of the video, audio and subpicture (SUBPCn) data streams. For ease of illustration herein, only one video bar 410, one audio bar 415 and three subpicture bars (SUBPC1-SUBPC3), 420, 425, 430, are shown. In this example, the three subpicture streams are to be used for the subtitles in the three different languages. Obviously, in a practice, all other video, audio and subpicture streams would also be accessible to an author via the timeline 325.

In use, an author selects, using the standard pointer device, and then drags and drops the icons, 310 and 315, from the first area 305 onto the appropriate bars 405 of the timeline 325 in the second area 320. So-called ‘drag and drop’ operations of this kind are commonplace in computer windowing environments, such as Microsoft™ Windows™. In response, the authoring system 200 changes the appearance of the timeline 325, in order to indicate that the assets or captions files have been assigned to the timeline, and then generates a project map 245, which reflects the assets on the timeline 325. The project map 245, which, in effect, describes the audiovisual asset structure of the DVD project, is eventually used to build a DVD image 237, as will be described below. An author can fine-tune the properties, for example start and end times, of each audiovisual asset on the timeline 325 by selecting the respective audiovisual asset on the timeline and modifying its properties (not shown) in the properties dialog box 330.

The diagram in FIG. 5 represents the timeline 325, according to the present embodiment, after the icons, 310 and 315, from the first area 305 have been dragged and dropped onto the timeline. As shown, the video clip asset 312 has been added to the video bar 410, the audio clip asset 313 has been added to the audio bar 415, and the three caption files, 316-318, have been added to the three subpicture bars, 420-430.

An exemplary caption file 316 is illustrated in FIG. 6. As shown, the caption data in the file comprises a plurality of text-based entries, which define the subtitles for the DVD project. Each line, or entry, of text in the file, which relates to one subtitle image frame of the project, includes at least:

(1) a subtitle text string 605 in one of the three languages (in this case English) for a respective subtitle image frame;

(2) a start time 610 (hours:minutes:seconds);

(3) an end time 615(hours:minutes:seconds);

(4) a font style 620 to be used for the subtitles; and

(5) a screen position 625 for the subtitle image frame.

Depending on the nature of the DVD project, the file may include other information, such as text colour, font kerning information or the like. In any event, according to the present embodiment, a subtitling operator (or operators) generate(s) a separate caption file for each subtitle language and send(s) the caption files to the DVD author. The caption files have a pre-determined structure and layout, since the files need to be readable by the authoring software, as will be described hereinafter.

The exemplary caption file 316 contains three entries, where each entry defines one subtitle frame. Each entry has a text string, a start and end time, a font style (in this case “Courier”) and a screen position (in this case “default”). In this example, since the captions are subtitles, the default screen position is in the bottom twenty percent of the viewable area of the screen.

In the exemplary caption file 316, the text strings are in English (EN), in the second caption file 317 the text strings are in equivalent Spanish (ES) and in the third caption file 318 the text strings are in equivalent German (DE).

As has already been described, the authoring system 200 generates a project map 245 using the timeline 325. An exemplary project map 245 is shown in FIG. 7. The project map 245 contains one line or entry for each asset or caption file. As illustrated, each entry in the project map 245 contains at least the following information:

(1) Data stream identifier 705;

(2) Start time 710 (hours:minutes:seconds);

(3) End time 715 (hours:minutes:seconds); and

(4) Storage path, or location, 720 of the asset or caption file.

The start 710 and end 715 times of the audiovisual assets are taken directly from the timeline 325, which has been defined by the author. The start and end times for the caption files are automatically set to coincide with the start and end times of the audiovisual assets with which the respective captions are associated. In other words, the start and end times for the caption file entries in this example are automatically set to 0 and 20 seconds respectively.

The present exemplary project map 245 is a relatively simple example of a project map, since each data stream has only one entry, and the respective start and end times of each entry are dictated by the duration of the video and audio streams. In more complex examples, it is likely that there will be multiple entries per data stream. However, the principles described herein apply equally both to simple and more complex examples.

The project map 245 is stored in the system memory 240 of the authoring system 200.

A process for generating a DVD image will now be described with reference to the flow diagram in FIG. 8.

According to FIG. 8, the process begins in a first step 800, in response to the author initiating the builder process 220. In step 805, the builder process 220 parses the project map 245 and expands the entries that relate to caption files 227. This step will be described in more detail below. In a step 810, the builder process 220 initiates a main loop process, which starts at time zero and ends at the latest end time of the entries in the project map 245. The main loop process increments by an appropriate amount of time on each iteration. For example, the loop may step by the frame rate of the respective DVD product. For each iteration of the main loop, in step 815, the builder process parses the project map 245 once more and, for each entry therein, streams an appropriate portion of an associated asset into a respective data stream location in the DVD image. In a step 820, the main loop process iterates unless it has just processed the final time frame. The process ends in step 825, at which point a final DVD image 237 is stored in the DVD image data store 235.

Step 805 of the foregoing process, which relates to producing an expanded project map, will now be described in more detail with reference to the flow diagram in FIG. 9.

According to FIG. 9, in a first step 900, the builder process initiates an outer loop process, which executes for each entry in the project map 245. In step 905, the builder process determines whether the current entry relates to a caption file 227. If the entry relates to an audiovisual asset 232, and not a caption file 227, then the process iterates in order to determine the nature of the next entry in the project map 245. If, however, the entry relates to a caption file 227, then, in step 910, the builder process 220 reads the caption file according to the path 720 in the entry and, in step 915, initiates an inner loop process, which executes for each entry in the caption file. In step 920, for each entry in the caption file 227, the builder process 220 writes a respective entry into the project map 245. Next, in step 925, the inner loop process iterates unless it has just processed the last entry in the caption file (cf) 227. In a next step, 930, the builder process 220 deletes from the project map 245 the entry that had identified the respective caption file 227. In a final step 935, the builder process iterates in order to process the next project map (pm) entry, unless that last entry has just been processed, in which case step 805 ends.

As illustrated in FIG. 10, each new entry (underlined) in the newly expanded project map 1045 maintains the data stream identifier 705 of the respective project map entry and also includes data from the respective caption file; including subtitle string 605, start time 610, end time 615, font style 620 and screen position 625.

Compared with the state of the project map in FIG. 7, it can be seen in FIG. 10 that each entry that had related to a caption file has been replaced by three new entries, which have been derived from the respective caption files.

Step 815 of the flow diagram in FIG. 8, which relates to building the DVD image 237, will now be described in more detail, with reference to the flow diagram in FIG. 11.

In FIG. 11, in a first step 1100, the builder process 220 initiates a loop process, which executes for each entry in the newly expanded project map (nepm) 1045. In step 1105, the builder process 220 determines whether a current time of the main loop process of FIG. 8 coincides with or falls within the start time and the end time of the respective entry. If the determination is negative, then the process jumps to step 1140, from where the loop iterates, unless the entry was the last entry in the project map, in which case step 815 ends. If the determination is positive, then, in step 1110, the builder process 220 determines whether the entry relates to a caption file 227. If the determination is positive, then, in step 1115, the builder process 220 calls the renderer process 215 and passes to it the respective text string 605, the font style 620 and the screen position information 625. In step 1120, the renderer process 215 generates a subtitle image file, using the information that has been passed to it. The image file is rendered, for example, as an appropriate TIFF or Targa formatted file in a known way. In step 1125, the renderer process 215 stores the rendered image file, as a temporary caption asset 250, in system memory 240. In step 1130, the renderer process 215 returns a respective system memory location pointer back to the builder process 215. In a step 1135, the builder process 220 extracts, or streams, an appropriate portion of the respective audiovisual asset, which is associated with the current entry in the project map 245, and adds that portion to the DVD image 237. In this case, the audiovisual asset can be either one that was pre-prepared and stored in the audiovisual asset data store 230 or one that has been generated by the renderer process 215 and stored in the system memory 240.

In relation to extracting or streaming an appropriate portion of an audiovisual asset, that is stored in the audiovisual asset data store 230, the builder process 220 opens the respective file 232, which is identified by the storage path 1020 in the respective expanded project map entry, and writes the appropriate portion into an appropriate location in the DVD image 237. For example, in the case where the audiovisual asset is an audio or a video clip, then an appropriate portion is one frame's worth of the clip.

In relation to extracting or streaming an appropriate portion of a temporary caption asset 250, that is stored in system memory 240, the builder process 220 accesses the system memory, using the returned memory pointer, and streams the entire asset into an appropriate location in the DVD image 237. In this case, the entire image is required, since an entire subtitle image needs to be displayed with each frame. Indeed, it will be understood that any audiovisual asset that represents an image for use in a subpicture stream would be added in its entirety to an appropriate location in the DVD image in this manner.

Finally, in step 1140, the builder process 220 iterates in order to process the next project map entry, unless that last entry has just been processed, in which case step 815 ends.

By way of example, after the main loop of the flow diagram in FIG. 8 is initiated, on the first iteration, at a time 00:00:00, the following assets, or appropriate portions thereof, are added to their identified data stream locations in the DVD image:

Video, 00:00:00, 00:00:20, AV_asset_store_312;

Audio, 00:00:00, 00:00:20, AV_asset_store_313;

Subpc1, “First EN subtitle string”, 00:00:00, 00:00:08, courier, default;

Subpc2, “First ES subtitle string”, 00:00:00, 00:00:08, courier, default;

Subpc3, “First DE subtitle string”, 00:00:00, 00:00:08, courier, default;

In this case, a first frame of the video and audio assets are added to an appropriate location in the DVD image. In addition, the entire first subtitle image frames in each of the three languages are rendered and then added to an appropriate location in the DVD image.

On the second iteration of the main loop, appropriate portions of the following assets are added to their identified data stream locations in the DVD image:

Video, 00:00:00, 00:00:20, AV_asset_store_312;

Audio, 00:00:00, 00:00:20, AV_asset_store_313;

In this case, only portions of the video and audio assets are added to an appropriate location in the DVD image, since the rendered images, associated with the subpicture streams, were added in their entirety in the first iteration. DVD players are arranged to load the subpicture images just before they are required and display the same data for as long as necessary.

When the main loop has iterated to reach eight seconds, the following assets, or appropriate portions thereof, are added to their identified data stream locations in the DVD image:

Video, 00:00:00, 00:00:20, AV_asset_store_312;

Audio, 00:00:00, 00:00:20, AV_asset_store_313;

Subpc1, “Second EN subtitle string”, 00:00:08, 00:00:14, courier, default;

Subpc2, “Second ES subtitle string”, 00:00:08, 00:00:14, courier, default;

Subpc3, “Second DE subtitle string”, 00:00:08, 00:00:14, courier, default;

In this case, a next frame of the video and audio assets is added to an appropriate location in the DVD image. In addition, the entire second subtitle image frames in each of the three languages are rendered and then added to an appropriate location in the DVD image.

On the next iteration of the main loop, the following assets, or appropriate portions thereof, are added to their identified data stream locations in the DVD image:

Video, 00:00:00, 00:00:20, AV_asset_store_312;

Audio, 00:00:00, 00:00:20, AV_asset_store_313;

Again, in this case, only portions of the video and audio assets are added to an appropriate location in the DVD image, since the rendered images, associated with the subpicture streams, were added in their entirety in the previous iteration.

When the main loop has iterated to reach fourteen seconds, the following assets, or appropriate portions thereof, are added to their identified data stream locations in the DVD image:

Video, 00:00:00, 00:00:20, AV_asset_store_312;

Audio, 00:00:00, 00:00:20, AV_asset_store_313;

Subpc1, “Third EN subtitle string”, 00:00:14, 00:00:20, courier, default;

Subpc2, “Third ES subtitle string”, 00:00:14, 00:00:20, courier, default;

Subpc3, “Third DE subtitle string”, 00:00:14, 00:00:20, courier, default;

In this case, a next frame of the video and audio assets is added to an appropriate location in the DVD image. In addition, the entire third subtitle image frames in each of the three languages are rendered and then added to an appropriate location in the DVD image.

On a final iteration of the main loop, the last frames of the following video and audio assets are added to their identified data stream locations in the DVD image:

Video, 00:00:00, 00:00:20, AV_asset_store_312;

Audio, 00:00:00, 00:00:20, AV_asset_store_313;

The skilled person will appreciate that, in practice, an authoring system will be arranged to build a DVD image in which content appears in its data stream slightly in advance of when it is needed for playback. For example, the content may appear a few frames or even up to several seconds in advance of when it is required for playback. Then, during playback, a DVD player is arranged to buffer the respective content until actual reproduction thereof is required. Use of buffering in this way enables a DVD player to switch seamlessly between content that is stored on different areas of a DVD. The foregoing examples should be read in this context.

Additionally, the skilled person will understand that the authoring system 200, which is described herein, is merely one exemplary arrangement of many possible arrangements that could be used to author an audiovisual production. For example, a system may reside entirely on local apparatus or be distributed between plural apparatus or systems connected by a local or wide area network, such as an Ethernet™ or even the Internet. Likewise, the authoring process described herein is merely one example of an authoring process that could apply the teachings of embodiments of the present invention.

The skilled person will also appreciate that the foregoing exemplary embodiment neglects to mention other commonly-used audiovisual assets and respective data streams, for example multiple angle video data streams, multiple language audio data streams, subpicture streams relating to menus and buttons and the like. The skilled person will, however, appreciate that the principles described herein would not be altered were a more complex DVD product, including some or all of these other data streams, to be authored.

Additionally, the description of the exemplary embodiment does not refer to generation of navigation data, which is used to control access to the presentation data in a DVD product, since generating navigation data is well known in the art of DVD authoring.

The skilled person will furthermore appreciate that the principles set forth herein can be applied to authoring an audiovisual product containing Closed Captions, background information, commercial information or similar. In those cases, the renderer process would be adapted to take in the raw caption data and generate caption assets in the required form. For example, for background information or commercial information, as for subtitles, the renderer process would generate appropriate image files based on the respective raw caption files and the builder process would add that information to the appropriate subpicture data streams. Similarly, for Closed Captions, the renderer process would produce a character-based file, which is formatted according to the Closed Caption format, and the builder process would be adapted to add that information to the Closed Caption data stream rather than a subpicture Data stream.

Indeed, by following the principles set forth herein, the authoring system may be adapted to generate any combination of two or more of any of the different kinds of caption.

1. An authoring system for authoring an audiovisual production comprising audiovisual content and accompanying captions, the system comprising: a first data store for storing audiovisual assets; a second data store for storing raw caption data; means for generating caption assets, using the raw caption data, and storing the caption assets in a third data store; and, means for generating the audiovisual production, using at least the audiovisual assets and the caption assets, and storing the audiovisual production in a fourth data store.

2. A system according to claim 1, comprising means for generating a data structure including references to stored audiovisual assets and stored raw caption data.

3. A system according to claim 1, comprising means for generating an expanded data structure including references to stored audiovisual assets and individual caption frames, which are identified in the stored raw caption data.

4. A system according to claim 3, wherein at least some of the references include caption text.

5. A system according to claim 3, wherein at least some of the references include timing information.

6. A system according to claim 3, wherein at least some of the references include storage path or location information.

7. A system according to claim 3, wherein at least some of the references include caption-formatting information.

8. A system according to claim 3, wherein at least some of the references include a data stream identifier.

9. A system according to claim 3, comprising means for generating the audiovisual product with accompanying captions including by using a data structure or an expanded data structure.

10. A system according to claim 1, wherein the raw caption data comprises plural text structures.

11. A system according to claim 10, wherein the raw caption data comprises timing data, which associates each text structure with a temporal point in the audiovisual product.

12. A system according to claim 10, wherein the raw caption data comprises formatting data, which describes a visual appearance associated with the text structures.

13. A system according to claim 10, wherein the raw caption data comprises placement data, which specifies an on-screen physical placement associated with at least some of the text structures.

14. A system according to claim 10, wherein the plural text structures comprise sets of text structures.

15. A system according to claim 14, wherein each set of text structures comprises an individual data file.

16. A system according to claim 14, wherein each set comprises substantially equivalent text in a different language.

17. An authoring system according to claim 1, wherein the caption assets comprise rendered image files.

18. An authoring system according to claim 1, wherein the caption assets comprise one or more formatted text files.

19. An authoring system according to claim 18, wherein the or each formatted text file contains character codes representing text to be displayed.

20. An authoring system according to claim 19, wherein the or each formatted text file contains at least one of timing information, formatting information and placement information, associated with each of the character codes.

21. A method of authoring an audiovisual production comprising audiovisual content and accompanying captions, comprising the steps:
providing audiovisual assets and raw caption data;
generating a data structure including references to the audiovisual assets and raw caption data;
generating caption assets, using the raw caption data; and
generating the audiovisual product by using the data structure and at least the referenced audiovisual assets and caption assets.

22. A method according to claim 21, including the step of expanding the data structure by including references to stored audiovisual assets and individual caption frames, which are identified in the stored raw caption data.

23. A method according to claim 22, including the step of altering the raw caption data, in-situ, after it has been provided.

24. A method according to claim 21, including the step of writing the audiovisual production to a data storage medium.

25. A method according to claim 24, wherein the data storage medium is a DLT tape carrier or an optical disc.

26. A system as claimed in claim 1, wherein the audiovisual production is a DVD-Video disc image.

27. An optical disc product produced including by using the system of claim 1.

28. An optical disc product according to claim 27, comprising a DVD-Video optical disc production.

29. An audiovisual authoring system product, comprising one or more software routines, modules or programs, which comprise instructions to control a programmable computer to operate, in accordance with user operations of the computer, according to the method of claim 21.

30. An audiovisual authoring system product, comprising one or more software routines, modules or programs, which comprise instructions to control a programmable computer to operate, in accordance with user operations of the computer, according to the authoring system of claim 1.

31. An audiovisual production generated using a system according to claim 1.
